(19) United States
(12) Patent Application Publication
(10) Pub. No.: US 2016/0144598 A1
(43) Pub. Date: May 26, 2016

(54) Composite structure

(71) Applicant: WANG SHUI MU, Taichung City (TW)

(72) Inventor: WANG SHUI MU, Taichung City (TW)

(21) Appl. No.: 14/551,180

(22) Filed: Nov. 24, 2014

(51) Int. Cl. B32B 7/04; B32B 3/26; B32B 3/28; B32B 27/12; B32B 5/18; B32B 27/08; B32B 27/06; B32B 3/30; B32B 5/02

(52) U.S. Cl. CPC B32B 7/04; B32B 3/30; B32B 3/266; B32B 3/28; B32B 5/022; B32B 5/024; B32B 5/18; B32B 27/08; B32B 27/065; B32B 27/12; B32B 2437/02; B32B 2439/00

(57) ABSTRACT

A composite structure contains a substrate and a surface material. The substrate includes a plurality of recesses defined on a top surface thereof, and each recess has a bottom face and a peripheral fence. The surface material is a thermoplastic material and includes a high temperature resist layer and a low temperature melting layer, wherein a melting point of the low temperature melting layer is lower than that of the high temperature resistant layer. The surface material is placed on the top surface of the substrate and is heated to soften its high temperature resistant layer and to melt the low temperature melting layer, thereafter the low temperature meting layer is permeated into plural pores of the substrate by using a negative pressure, and the high temperature layer extends and covers the top surface of the substrate and the plurality of recesses.

### FIELD OF THE INVENTION

The present invention relates to a composite structure in which a surface layer is connected with a substrate easily and quickly.

### BACKGROUND OF THE INVENTION

A shoe or a purse is made of a conventional composite material which contains a substrate made of cloth material, an adhesive layer coated on a top surface of the substrate, and a thermoplastic layer attached on the adhesive layer. However, such a conventional composite material is heavy and is manufactured troublesomely.

The present invention has arisen to mitigate and/or obviate the afore-described disadvantages.

### SUMMARY OF THE INVENTION

The primary object of the present invention is to provide a composite structure in which a surface layer is connected with a substrate easily and quickly.

To obtain the above objects, a composite structure provided by the present invention contains: a substrate and a surface material.

The substrate includes a plurality of recesses defined on a top surface thereof, and each recess has a bottom face formed therein and a peripheral fence arranged around an inner wall thereof.

The surface material is a thermoplastic material and includes a high temperature resist layer formed on an upper portion thereof and a low temperature melting layer formed on a lower portion thereof, wherein a melting point of the low temperature melting layer is lower than that of the high temperature resistant layer.

The surface material is placed on the top surface of the substrate and is heated to soften its high temperature resistant layer and to melt the low temperature melting layer, thereafter the low temperature meting layer is permeated into plural pores of the substrate by using a negative pressure, and the high temperature layer extends and covers the top surface of the substrate and the plurality of recesses.

### BRIEF DESCRIPTION OF THE DRAWINGS

FIG. 1 is a perspective view showing the exploded components of a composite structure according to a first embodiment of the present invention.

FIG. 2 is a perspective view showing the assembly of the composite structure according to the first embodiment of the present invention.

FIG. 3 is a cross sectional view showing the assembly of a part of the composite structure according to the first embodiment of the present invention.

FIG. 4 is a cross sectional view showing the assembly of a part of a composite structure according to a second embodiment of the present invention.

FIG. 5 is a cross sectional view showing the assembly of a part of a composite structure according to a third embodiment of the present invention.

FIG. 6 is a cross sectional view showing the assembly of a part of a composite structure according to a fourth embodiment of the present invention.

FIG. 7 is a cross sectional view showing a substrate of the composite structure including a first layer and a second layer according to the first embodiment of the present invention.

FIG. 8 is a cross sectional view showing the substrate of the composite structure including the first layer, the second layer, and a third layer according to the first embodiment of the present invention.

### DETAILED DESCRIPTION OF THE PREFERRED EMBODIMENTS

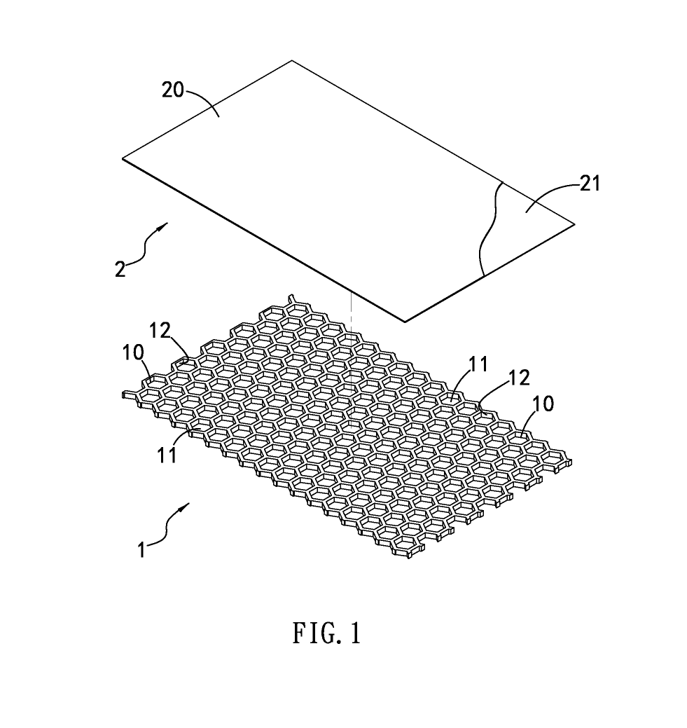

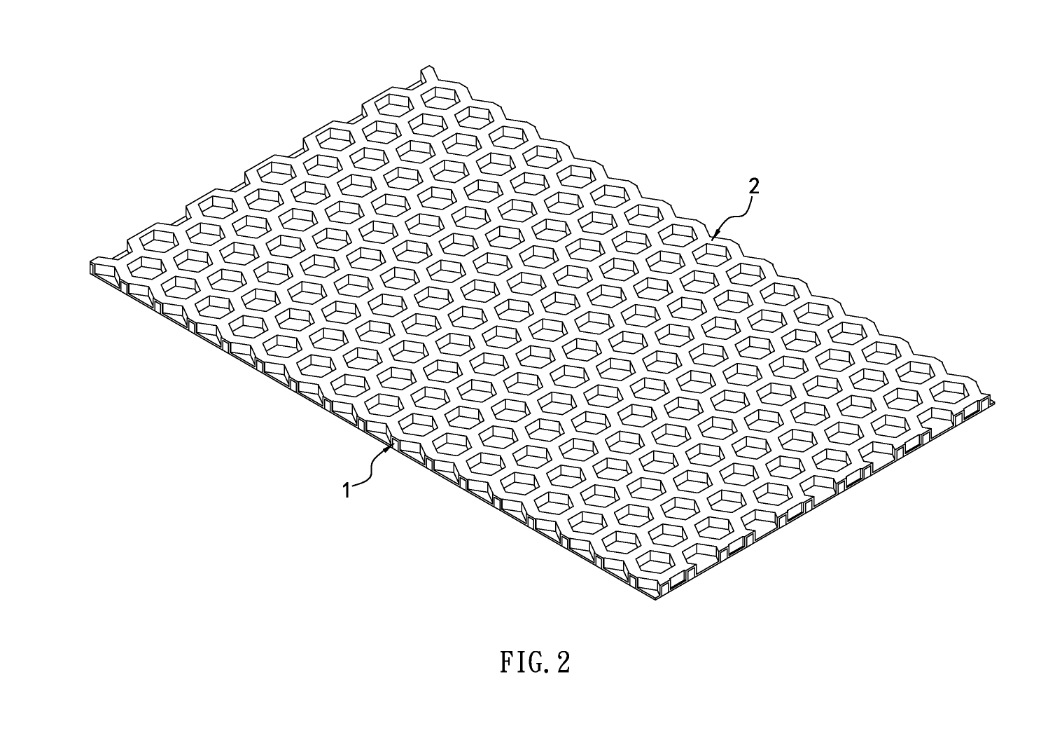

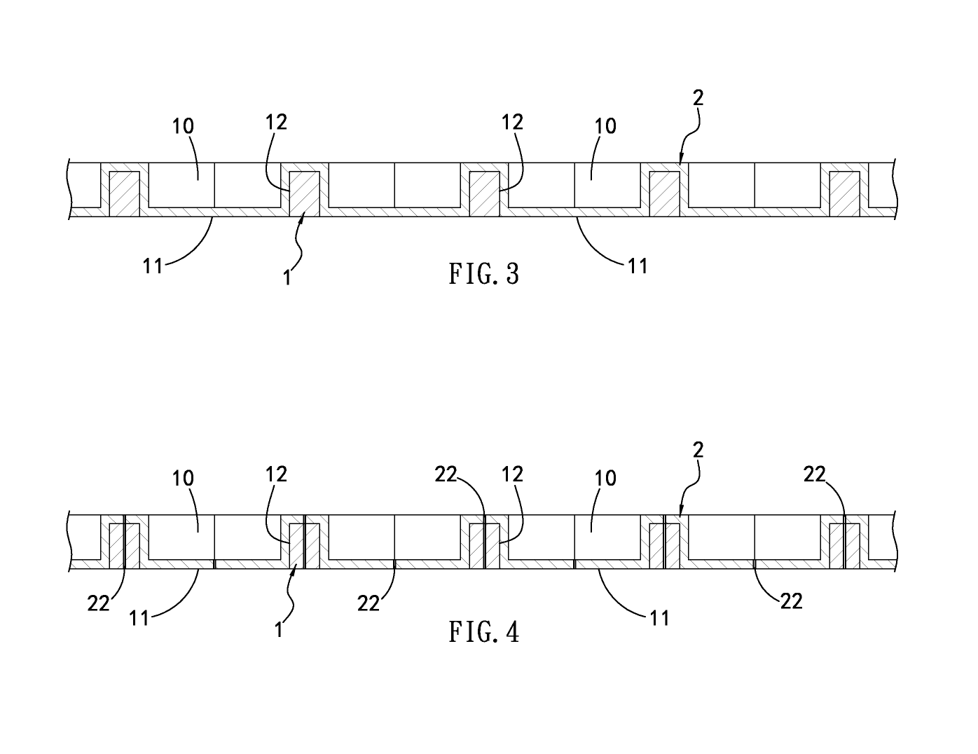

With reference to FIGS. 1 to 3, a composite structure according to a first embodiment of the present invention comprises: a substrate 1 and a surface material 2.

The substrate 1 is a cloth material (such as a woven cloth, a non-woven cloth, or a needle punched fabric) or a foam material. The substrate 1 includes a plurality of recesses 10 defined on a top surface thereof, and each recess 10 has a bottom face 11 formed therein and a peripheral fence 12 arranged around an inner wall thereof.

The surface material 2 is a thermoplastic material, such as TPU, EVA, PU or TPR. The surface material 2 includes a high temperature resist layer 20 formed on an upper portion thereof and a low temperature melting layer 21 formed on a lower portion thereof, wherein a melting point of the low temperature melting layer 21 is 20° C. lower than that of the high temperature resistant layer 20.

The surface material 2 is placed on the top surface of the substrate 1 and is heated to soften its high temperature resistant layer 20 and to melt the low temperature melting layer 21, thereafter the low temperature meting layer 21 is permeated into plural pores of the substrate 1 by using a negative pressure, and the high temperature layer 20 extends and covers the top surface of the substrate 1 and the plurality of recesses 10, thus connecting the surface layer 2 with the substrate 1 easily and quickly.

Preferably, after the low temperature melting layer 21 is melted to permeate into the plural pores of the substrate 1, the surface material 2 is connected with the substrate 1 tightly without increasing thickness and weight of the composite structure, thus obtaining compact purpose.

Referring to FIG. 4, a difference of a composite structure of a second embodiment from that of the first embodiment comprises: after the surface material 2 is connected with the substrate 1, a needle plate (not shown) is extended out of plural micropores 22 of the surface material 2 and the substrate 1, wherein a diameter of each micropore 22 is 0.001 mm to 1.0 mm, such that the composite structure has excellent air permeation by ways of the plural micropores 22.

As shown FIG. 5, a difference of a composite structure of a third embodiment from that of the first embodiment comprises: a surface material 2 including plural three-dimensional patterns 23 arranged on a top surface thereof to achieve aesthetics appearance.

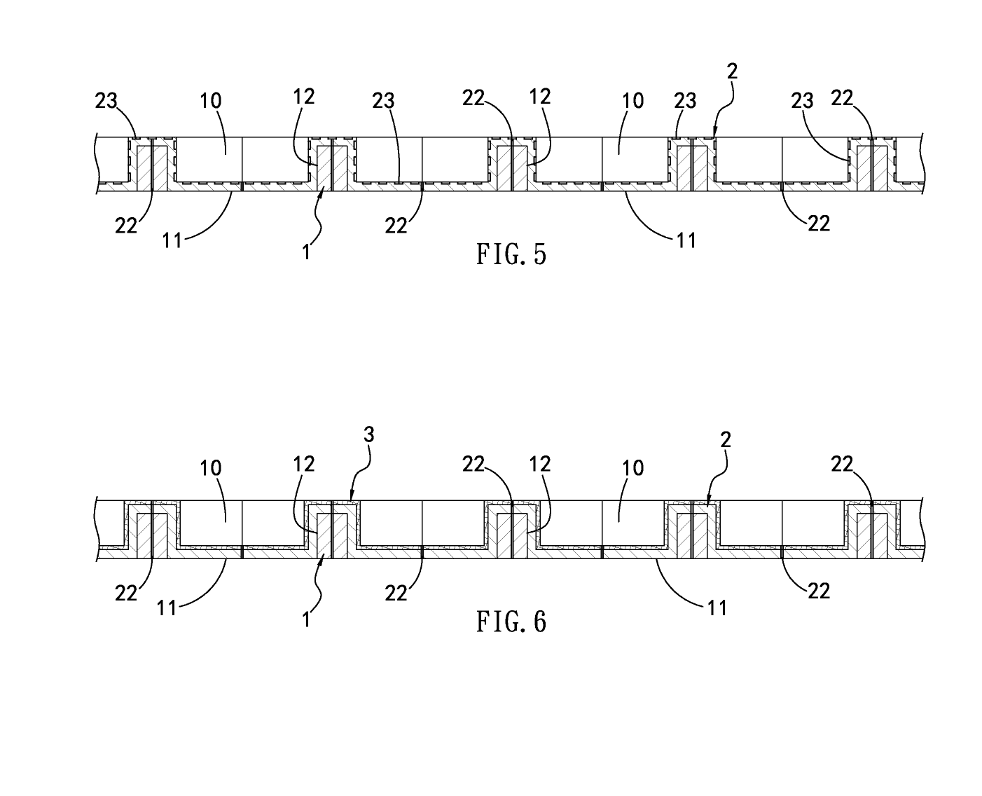

As shown FIG. 6, a difference of a composite structure of a fourth embodiment from that of the first embodiment comprises: a surface layer 3 covering the high temperature resistant layer 20 of the surface material 20 in a plating, a laser coating, or a spray manner; and plural micropores 22 pass through the surface layer 3. In this embodiment, the surface layer 3 is a plating film, a laser film or a light reflective film, thus enhancing visual effect and touch sense.

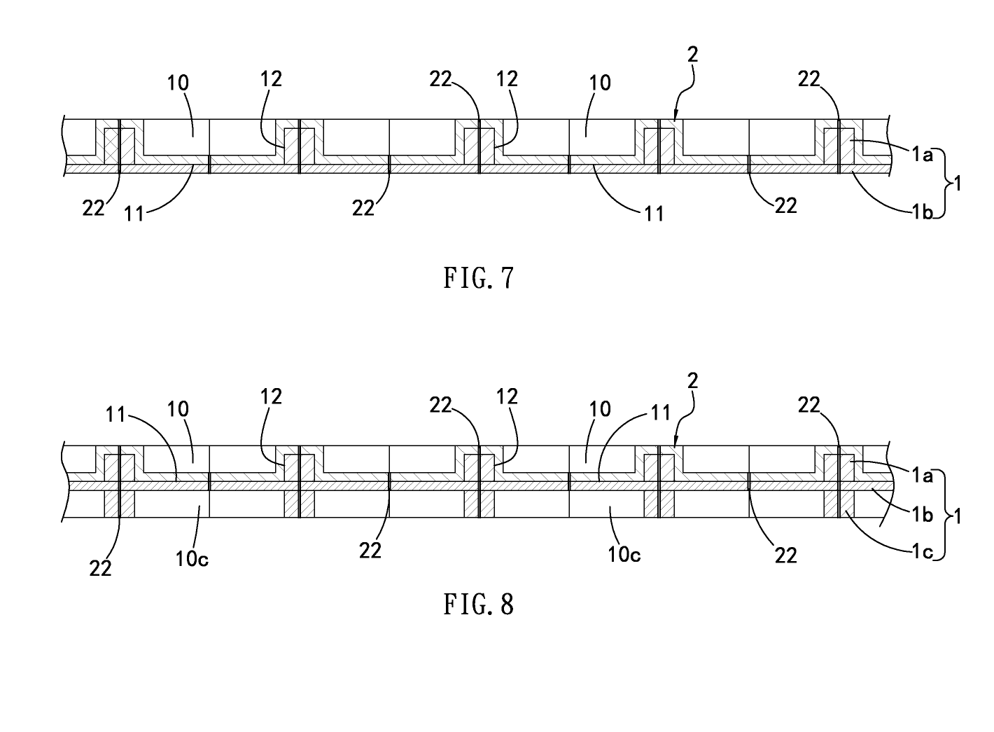

As illustrated in FIG. 7, the substrate 1 includes a first layer 1a and a second layer 1b. The plurality of recesses 10 are defined on a top surface of the first layer 1a, and a top surface of the second layer 1b is connected with or one piece formed with a bottom surface of the first layer 1a, such that the bottom face 11 of each recess 10 is closed. The surface material 2 is melted to couple with the top surface of the first layer 1a and the peripheral fence 12 of each recess 10, and the top surface of the second layer 1b corresponds to the bottom face 11 of each recess 10, wherein the first layer 1a and the second layer 1b are both made of a cloth material or a foam material. Alternatively, one of the first layer 1a and the second layer 1b is made of cloth material, and the other of the first layer 1a and the second layer 1b is made of foam material.

With reference to FIG. 8, the substrate 1 further includes a third layer 1c, wherein a top surface of the third layer 1c is connected with or one piece formed with the bottom surface of the second layer 1b, and the third layer 1c has plural notches 10c defined on a bottom surface thereof, wherein the third layer 1c is made of cloth material or foam material.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A composite structure comprising:
a substrate including a plurality of recesses defined on a top surface thereof, and each recess having a bottom face formed therein and a peripheral fence arranged around an inner wall thereof;
a surface material being a thermoplastic material and including a high temperature resist layer formed on an upper portion thereof and a low temperature melting layer formed on a lower portion thereof, wherein a melting point of the low temperature melting layer is lower than that of the high temperature resistant layer; wherein
the surface material is placed on the top surface of the substrate and is heated to soften its high temperature resistant layer and to melt the low temperature melting layer, and the low temperature meting layer is permeated into plural pores of the substrate by using a negative pressure and is intermediate the high temperature resist layer of the surface material and the substrate, and the high temperature layer extends and covers the top surface of the substrate and the plurality of recesses;
wherein after the surface material is connected with the substrate, a needle plate is extended out of plural micropores of the surface material and the substrate.

2. (canceled)

3. The composite structure as claimed in claim 1, wherein a diameter of each micropore is 0.001 mm to 1.0 mm.

4. The composite structure as claimed in claim 1, wherein a melting point of the low temperature melting layer is 20° C. lower than that of the high temperature resistant layer.

5. The composite structure as claimed in claim 1, wherein the surface material is any one of Thermoplastic Urethane (TPU), Ethylene-Vinyl Acetate (EVA), Polyurethane (PU) and Thermoplastic Rubber (TPR).

6. The composite structure as claimed in claim 1, wherein the surface material includes plural three-dimensional patterns arranged on a top surface thereof.

7. The composite structure as claimed in claim 1 further comprising a surface layer covering the high temperature resistant layer of the surface material.

8. The composite structure as claimed in claim 1 further comprising a surface layer covering the high temperature resistant layer of the surface material, and the plural micropores passing through the surface layer.

9. The composite structure as claimed in claim 7, wherein the surface layer is any one of a plating film, a laser film and a light reflective film.

10. The composite structure as claimed in claim 1, wherein the substrate is a cloth material.

11. The composite structure as claimed in claim 10, wherein the cloth material is any one of a woven cloth, a non-woven cloth, and a needle punched fabric.

12. The composite structure as claimed in claim 1, wherein the substrate is a foam material.

13. The composite structure as claimed in claim 1, wherein the substrate includes a first layer and a second layer, the plurality of recesses are defined on a top surface of the first layer, and a top surface of the second layer is connected with a bottom surface of the first layer, the bottom face of each recess is closed, the surface material is melted to couple with the top surface of the first layer and the peripheral fence of each recess, and the top surface of the second layer corresponds to the bottom face of each recess.

14. The composite structure as claimed in claim 13, wherein one of the first layer and the second layer is made of cloth material, and the other of the first layer and the second layer is made of foam material.

15. The composite structure as claimed in claim 13, wherein the substrate further includes a third layer, and a top surface of the third layer is connected with the bottom surface of the second layer, the third layer has plural notches defined on a bottom surface thereof.

16. The composite structure as claimed in claim 15, wherein one of the first layer and the second layer is made of cloth material, and the other of the first layer and the second layer is made of foam material.

17. The composite structure as claimed in claim 16, wherein the third layer is made of cloth material or foam material.
